(19) United States
(12) Patent Application Publication
(10) Pub. No.: US 2023/0317086 A1
(43) Pub. Date: Oct. 5, 2023

(54) PRIVACY-PRESERVING SOUND REPRESENTATION

(71) Applicant: TAMPERE UNIVERSITY FOUNDATION SR, Kalevantie 4 (FI)

(72) Inventors: Tuomas VIRTANEN, TAMPEREEN YLIOPISTO (FI); Toni HEITTOLA, TAMPEREEN YLIOPISTO (FI); Shuyang ZHAO, TAMPEREEN YLIOPISTO (FI); Shayan GHARIB, TAMPEREEN YLIOPISTO (FI); Konstantinos DROSOS, TAMPEREEN YLIOPISTO (FI)

(21) Appl. No.: 18/025,240

(22) PCT Filed: Sep. 8, 2021
(86) PCT No.: PCT/FI2021/050597

§ 371 Date: Mar. 8, 2023

(30) Foreign Application Priority Data
Sep. 8, 2020 (FI) 20205870

(51) Int. Cl. G10L 17/26; G10L 25/51; G10L 25/27

(52) U.S. Cl. CPC G10L 17/26; G10L 25/51; G10L 25/27

(57) ABSTRACT

According to an example embodiment, a method (200) for audio-based monitoring is provided, the method (200) comprising: deriving (202), via usage of a predefined conversion model (M), based on audio data that represents sounds captured in a monitored space, one or more audio features that are descriptive of at least one characteristic of said sounds; identifying (204) respective occurrences of one or more predefined acoustic events in said space based on the one or more audio features; and carrying out (206), in response to identifying an occurrence of at least one of said one or more predefined acoustic events, one or more predefined actions associated with said at least one of said one or more predefined acoustic events, wherein said conversion model (M) is trained to provide said one or more audio features such that they include information that facilitates identification of respective occurrences of said one or more predefined acoustic events while preventing identification of speech characteristics.

### TECHNICAL FIELD

The example and non-limiting embodiments of the present invention relate to processing of sound and, in particular, to providing sound representation that retains information characterizing environmental sounds of interest while excluding information characterizing any selected aspects of speech content possibly included in the original sound.

### BACKGROUND

In a modern living and monitored environment, electronic devices can greatly benefit from understanding their surroundings. For example, home automation kits can interact with the other devices in their proximity (e.g. ones in the same space) or with remote devices (e.g. with a server device over the network) in response to detecting certain sound events in their operating environment. Examples of such sound events of interest include sounds arising from glass breaking, a person falling down, water running, etc. Although images and video can be used for monitoring, in many scenarios sound-based monitoring has certain advantages that makes it an important or even preferred information source for monitoring applications. As an example in this regard, sound does not require a direct or otherwise undisturbed propagation path between a source and a receiver, e.g. a sound arising from an event in a room next door can be typically captured at a high sound quality while it may not be possible to capture an image or video in such a scenario. As another example, sound capturing is robust in various environmental conditions, e.g. a high quality sound can be captured regardless of lighting conditions, while poor lighting conditions may make image or video based monitoring infeasible.

On the other hand, despite its apparent advantages, usage of sound to represent events of interest in a monitoring application may pose serious threats to privacy. In particular, access to a sound signal captured in a private environment such as home or office may open a possibility for a malicious observer to extract speech related information such as information pertaining to speech activity, speech content, and/or the identity of the speaker in the monitored space, which may result in invasion of privacy either directly (e.g. by making use of the information on the speech content and/or the identity of speaker) or indirectly (e.g. by making use of information concerning the presence or absence of people in the monitored space). Typically, intelligent home devices that are arranged for monitoring sound events in a monitored space carry out predefined local processing of the audio data and transmit the processed audio data to a remote server for sound event detection therein. In such a scenario, if the audio data captured at the home device represents speech, a third party that may be able to intercept the transmission including the processed audio data and/or to get unauthorized access to the processed audio data in the remote server may obtain access to the speech related information therein, thereby leading into compromised privacy and security.

Previously known solutions that may be applicable for removing or at least reducing speech related information in an audio signal before transmitting the audio data for the remote server include filtering solutions for suppressing speech content possibly present in the audio signal and source separation techniques for separating possible speech content from other sound sources of the audio signal before transmitting the non-speech content of the audio signal to the remote server. However, such methods do not typically result in fully satisfactory results in suppressing the speech content and/or with respect to the quality of the speech-removed audio data.

### SUMMARY

Objects of the present invention include providing a technique that facilitates processing of audio data that represents a sound in a space into a format that enables detection of desired sound events occurring in the space while preserving or at least improving privacy within the space and providing at least partially sound-based monitoring system that makes of such a technique.

According to an example embodiment, a monitoring system is provided, the system comprising: an audio preprocessor arranged to derive, via usage of a predefined conversion model, based on audio data that represents sounds captured in a monitored space, one or more audio features that are descriptive of at least one characteristic of said sounds; an acoustic event detection server arranged to identify respective occurrences of one or more predefined acoustic events in said space based on the one or more audio features; and an acoustic event processor arranged to carry out, in response to identifying an occurrence of at least one of said one or more predefined acoustic events, one or more predefined actions associated with said at least one of said one or more predefined acoustic events, wherein said conversion model is trained to provide said one or more audio features such that they include information that facilitates identification of respective occurrences of said one or more predefined acoustic events while preventing identification of speech characteristics.

According to another example embodiment, an apparatus for deriving a conversion model for converting an audio data item that represent captured sounds into one or more audio features that are descriptive of at least one characteristic of said sounds and an acoustic event classifier is provided, the apparatus is arranged to apply machine learning to jointly derive the conversion model, the acoustic event classifier and a speech classifier via an iterative learning procedure based on a predefined dataset that includes a plurality of audio data items that represent respective captured sounds including at least a first plurality of audio data items that represent one or more predefined acoustic events and a second plurality of audio data items that represent one or more predefined speech characteristics such that the acoustic event classifier is trained to identify respective occurrences of said one or more predefined acoustic events in an audio data item based on one or more audio features obtained via application of the conversion model to said audio data item, the speech classifier is trained to identify respective occurrences of said one or more predefined speech characteristics in an audio data item based on one or more audio features obtained via application of the conversion model to said audio data item, and the conversion model is trained to convert an audio data item into one or more audio features such that they include information that facilitates identification of respective occurrences of said one or more predefined acoustic events via application of the acoustic event classifier while they substantially prevent identification of respective occurrences of said one or more predefined speech characteristics via application of the speech classifier.

According to another example embodiment, a method for audio-based monitoring is provided, the method comprising: deriving, via usage of a predefined conversion model, based on audio data that represents sounds captured in a monitored space, one or more audio features that are descriptive of at least one characteristic of said sounds; identifying respective occurrences of one or more predefined acoustic events in said space based on the one or more audio features; and carrying out, in response to identifying an occurrence of at least one of said one or more predefined acoustic events, one or more predefined actions associated with said at least one of said one or more predefined acoustic events, wherein said conversion model is trained to provide said one or more audio features such that they include information that facilitates identification of respective occurrences of said one or more predefined acoustic events while preventing identification of speech characteristics.

According to another example embodiment, a method for deriving a conversion model is provided, wherein the conversion model is applicable for converting an audio data item that represent captured sounds into one or more audio features that are descriptive of at least one characteristic of said sounds and an acoustic event classifier via application of machine learning to jointly derive the conversion model, the acoustic event classifier and a speech classifier via an iterative learning procedure based on a predefined dataset that includes a plurality of audio data items that represent respective captured sounds including at least a first plurality of audio data items that represent one or more predefined acoustic events and a second plurality of audio data items that represent one or more predefined speech characteristics, the method comprising: training the acoustic event classifier to identify respective occurrences of said one or more predefined acoustic events in an audio data item based on one or more audio features obtained via application of the conversion model to said audio data item; training the speech classifier to identify respective occurrences of said one or more predefined speech characteristics in an audio data item based on one or more audio features obtained via application of the conversion model to said audio data item; and training the conversion model to convert an audio data item into one or more audio features such that they include information that facilitates identification of respective occurrences of said one or more predefined acoustic events via application of the acoustic event classifier while they substantially prevent identification of respective occurrences of said one or more predefined speech characteristics via application of the speech classifier.

According to another example embodiment, a computer program is provided, the computer program comprising computer readable program code configured to cause performing at least a method according to an example embodiment described in the foregoing when said program code is executed on one or more computing apparatuses.

The computer program according to the above-described example embodiment may be embodied on a volatile or a non-volatile computer-readable record medium, for example as a computer program product comprising at least one computer readable non-transitory medium having the program code stored thereon, which, when executed by one or more computing apparatuses, causes the computing apparatuses at least to perform the method according to the example embodiment described in the foregoing.

The exemplifying embodiments of the invention presented in this patent application are not to be interpreted to pose limitations to the applicability of the appended claims. The verb “to comprise” and its derivatives are used in this patent application as an open limitation that does not exclude the existence of also unrecited features. The features described hereinafter are mutually freely combinable unless explicitly stated otherwise.

Some features of the invention are set forth in the appended claims. Aspects of the invention, however, both as to its construction and its method of operation, together with additional objects and advantages thereof, will be best understood from the following description of some example embodiments when read in connection with the accompanying drawings.

### BRIEF DESCRIPTION OF FIGURES

The embodiments of the invention are illustrated by way of example, and not by way of limitation, in the figures of the accompanying drawings, where

FIG. 1 illustrates a block diagram of some logical elements of a monitoring system according to an example;

FIG. 2 illustrates a block diagram of some logical elements of a monitoring system according to an example;

FIG. 3 illustrates a block diagram of some logical elements of a monitoring system according to an example;

FIG. 4 schematically illustrates a conversion procedure according to an example;

FIG. 5 schematically illustrates a sound event classification procedure according to an example;

FIG. 6 schematically illustrates a speech classification procedure according to an example;

FIG. 7 illustrates a method according to an example;

FIG. 8 illustrates a method according to an example; and

FIG. 9 illustrates a block diagram of some components of an apparatus according to an example.

### DESCRIPTION OF SOME EMBODIMENTS

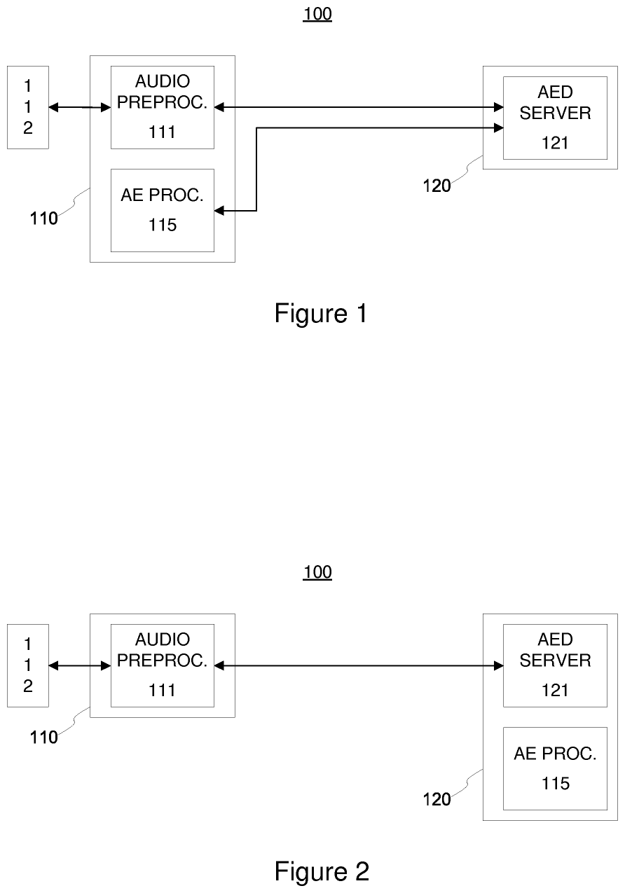

FIG. 1 illustrates a block diagram of some logical elements of a monitoring system 100 that is arranged to apply at least sound-based monitoring according to an example. The monitoring system 100 as depicted in FIG. 1 comprises an audio preprocessor 111 for deriving, based on an audio data that represents a sound captured in a monitored space, one or more audio features that are descriptive of at least one characteristic of the captured sound and an acoustic event detection (AED) server 121 for identifying respective occurrences of one or more predefined acoustic events (AEs) in the monitored space based on the one or more audio features. The audio data may comprise a (segment of an) audio signal that represents the sound captured in the monitored space or a set of initial audio features derived therefrom, whereas derivation of the one or more audio features based on the audio data may be carried out via usage of a predefined conversion model. Depending on characteristics of the audio data and the applied conversion model, the resulting one or more audio features may comprise a modified audio signal converted from the audio signal received at the audio preprocessor 111 or one or more audio features converted from the initial audio features. Respective characteristics of the audio data, the conversion model and the one or more audio features are described in further detail in the following. Moreover, for brevity and clarity of description, the present disclosure may alternatively refer to identification of respective occurrences of the one or more predefined acoustic events in an audio feature vector (that includes the one or more audio features) when referring to identification of respective occurrences of the one or more in predefined sound events in the monitored space.

The audio preprocessor 111 is intended for arrangement in or in proximity of the monitored space, whereas the AED server 121 may be arranged outside the monitored space and it may be communicatively coupled to the audio preprocessor 111. Without losing generality, the AED server 121 may be considered to reside a remote location with respect to the audio preprocessor 111. The communicative coupling between the audio processor 111 and the AED server 121 may be provided via a communication network, such as the Internet.

The monitoring system 100 further comprises an acoustic event (AE) processor 115 for carrying out, in response to identifying an occurrence of at least one of the one or more predefined acoustic events, one or more predefined actions that are associated with said at least one of the one or more predefined acoustic events. In this regard, each of the one or more predefined acoustic events may be associated with respective one or more predefined actions that are to be carried out in response to identifying an occurrence of the respective predefined acoustic event in the monitored space. The AE processor 115 is communicatively coupled to the AED server 121, which communicative coupling may be provided via a communication network, such as the Internet. In the example of FIG. 1 the audio preprocessor 111 and the AE processor 115 are provided in a local device 110 arranged in or in proximity of the monitored space, whereas the AED server 121 is provided in a server device 120 that is arranged in a remote location with respect to the local device 110. In a variation of this example, the AE processor 115 may be provided in another device arranged in or in proximity of the monitored space, e.g. in the same or substantially in the same location or space with the audio preprocessor 111.

The audio preprocessor 111 may be communicatively coupled to a sound capturing apparatus 112 for capturing sounds in its environment, which, when arranged in the monitored space, serves to capture sounds in the monitored space. The sound capturing apparatus 112 may comprise one or more microphones for capturing sounds in the environment of the sound capturing apparatus 112, whereas each of the one or more microphones is arranged to capture a respective microphone signal that conveys a respective representation of the sounds in the environment of the sound capturing apparatus 112. The audio preprocessor 111 may be arranged to record, based on the one or more microphone signals, the audio signal that represents the sounds captured in the monitored space. The recorded audio signal or one or more initial audio features extracted therefrom may serve as the audio data applied as basis for deriving the one or more audio features via usage of the conversion model.

The monitored space may comprise any indoor or outdoor space within a place of interest, for example, a room or a corresponding space in a residential building, in an office building, in a public building, in a commercial building, in an industrial facility, an interior of a vehicle, in a yard, in a park, on a street, etc. According to an example, the one or more predefined acoustic events (AEs) the AED server 121 serves to identify based on the one or more audio features may include one or more predefined sound events. In such an example, the AED server 121 may be referred to as a sound event detection (SED) server and the AE processor 115 may be referred to as a sound event (SE) processor. Moreover, the one or more predefined sound events may include any sounds of interest expected to occur in the monitored space, whereas the exact nature of the one or more predefined sound events may depend on characteristics and/or expected usage of the monitored space and/or on the purpose of the local device 110 hosting components of the monitoring system 100 and/or on the purpose of the monitoring system 100. Non-limiting examples of such sound events of interest include sounds that may serve as indications of unexpected or unauthorized entry to the monitored space or sounds that may serve as indications of an accident or a malfunction occurring in the monitored space. Hence, depending on the usage scenario of the monitoring system 100, the sound events of interest may include sounds such as a sound of a glass breaking, a sound of forcing a door open, a sound of an object falling on the floor, a sound of dog barking, a sound of a gunshot, a sound of a person calling for help, a sound of a baby crying, a sound of water running or dripping, a sound of a person falling down, a sound of an alarm from another device or appliance, a sound of a vehicle crashing, etc.

In another example, the one or more acoustic events may comprise one or more acoustic scenes (ASs) and, consequently, the AED server 121 may be referred to as an acoustic scene classification (ASC) server and the AE processor 115 may be referred to as an acoustic scene (AS) processor. Moreover, since the ASC aims at identifying, based on the one or more audio features, a current acoustic environment represented by the underlying audio data, in such a scenario the audio preprocessor 111 (possibly together with the AS processor) may be provided in a mobile device such a mobile phone or a tablet computer. Further in this regard, the one or more predefined acoustic scenes the ASC server serves to identify may include any acoustic scenes of interest, e.g. one or more of the following: a home, an office, a shop, an interior of a vehicle, etc., whereas the exact nature of the one or more predefined acoustic scenes may depend on characteristics, on expected usage and/or on the purpose of the monitoring system 100. For the benefit of clarity and brevity of description but without imposing any limitation, in the following the examples pertaining to operation of the monitoring system 100 predominantly refer to the AED server 121 operating as the SED server for identification of one or more predefined sound events and the AE processor 115 operating as the SE processor in view of (possibly) identified respective occurrences of the one or more predefined sound events.

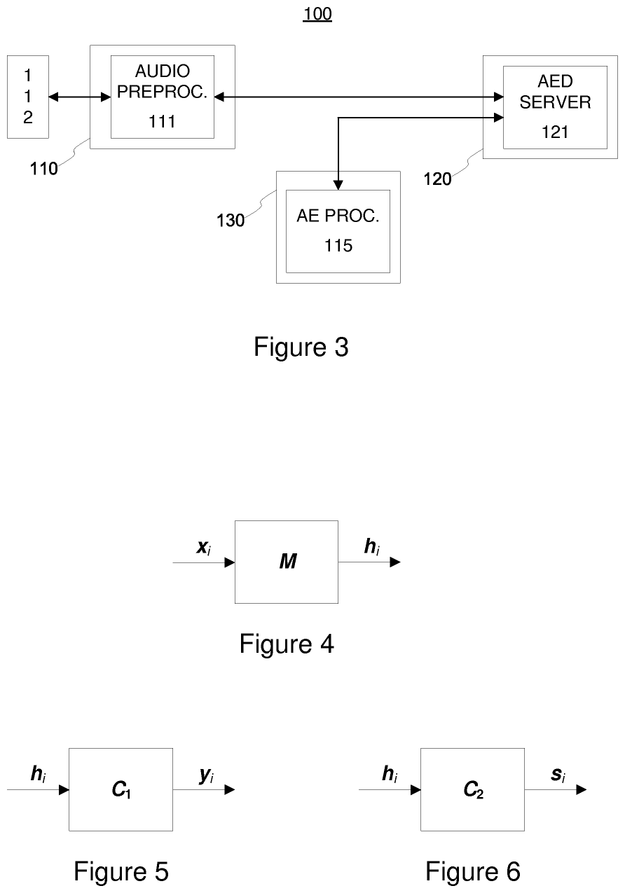

While the example of FIG. 1 depicts the monitoring system 100 as one where the audio preprocessor 111 and the AE processor 115 are provided in or in proximity of the monitored space while the AED server 121 is provided in a remote location, in other examples these elements may be located with respect to each other in a different manner. As an example in this regard, FIG. 2 illustrates a block diagram of the above-described logical elements of the monitoring system 100 arranged such the AE processor 115 is provided by the server device 120 in the remote location with respect to the audio preprocessor 111 together with the AED server 121. FIG. 3 illustrates a further exemplifying arrangement of the above-described logical elements of the monitoring system 100, where the AE processor 115 is provided by a further device 130 arranged in a second remote location with respect to the audio preprocessor 111, i.e. in a location that is also different from the location of the AED server 121 (and the server device 120).

As an example of operation of elements of the monitoring system 100, the audio preprocessor 111 may be arranged to derive one or more audio features based on the obtained audio data (e.g. a time segment of the recorded audio signal or one or more initial audio features extracted therefrom) and to transfer (e.g. transmit) the one or more audio features to the AED server 121. The AED server 121 may be arranged to carry out an AED procedure in order to identify respective occurrences of the one or more predefined AEs based on the one or more audio features and to transfer (e.g. transmit) respective indications of the identified one or more AEs (if any) to the AE processor 115. The AE processor 115, in turn, may carry out one or more predefined actions in dependence of the identified one or more AEs.

As a non-limiting example in this regard, the monitoring system 100 may be operated as (part of) a burglar alarm system e.g. such that predefined one or more sound events identifiable by the AED server 121 (operating as the SED sever) include respective sound events associated with sounds such as a sound of a glass breaking, a sound of forcing a door open, a sound of an object falling on the floor, a sound of a dog barking, a sound of a gunshot, a sound of a person calling for help, a sound of a baby crying, and/or another sounds that may be associated with a forced entry to the monitored space, whereas the one or more predefined actions to be carried out by the AE processor 115 (operating as the SE processor) in response to identifying one or more of the predefined sound events may comprise issuing an alarm (locally and/or by sending a message to a remote location).

Along the lines described in the foregoing, the audio preprocessor 111 may be arranged to derive one or more audio features based on the audio data obtained therein, where the one or more audio features are descriptive of at least one characteristic of the sound represented by the audio data. In this regard, the audio preprocessor 111 may process the audio data in time segments of predefined duration, which may be referred to as audio frames. Hence, the audio preprocessor 111 may be arranged to process a plurality of audio frames to derive respective one or more audio features that are descriptive of the at least one characteristic of the sound represented the respective audio frame. Without losing generality, the one or more audio features derived for an audio frame may be referred to as an audio feature vector derived for (and/or pertaining to) the respective audio frame. Herein, the audio frames may be non-overlapping or partially overlapping and the duration of an audio frame may be e.g. in a range from a few seconds to a few minutes, for example one minute. An applicable frame duration may be selected, for example, in view of the type of the one or more audio features, in view the procedure applied for deriving the one or more audio features and/or in view of the application of the monitoring system 100.

In an example, the audio preprocessor 111 may use the audio signal recorded thereat as the audio data and apply the conversion model (that is described in more detail in the following) to an audio frame to derive the one or more audio features that include the information that facilitates (e.g. enables) identification an occurrence of any of the one or more predefined sound events while inhibiting or preventing identification of speech related information possibly represented by the audio data. In another example, derivation of the one or more audio features for an audio frame may comprise the audio preprocessor 111 applying a predefined feature extraction procedure on said audio frame to derive one or more initial audio features and to apply the conversion model to the one or more initial audio features to derive the one or more audio features of the kind described above. Hence, in the latter example either the audio frame or the one or more initial audio features extracted therefrom may be considered as the audio data applied as basis for deriving the one or more audio features via usage of the conversion model, whereas the one or more audio features obtained via application of the conversion model to the one or more initial audio features may be also referred to as one or more converted audio features.

The examples with respect to usage and derivation of the conversion model described in the foregoing and in the following predominantly refer to an approach that involves conversion from the one or more initial audio features to the one or more (converted) audio features, while references to an approach involving direct conversion from the audio signal to the one or more audio features are made where applicable. Nevertheless, the usage and derivation of the conversion model may be based on a ‘raw’ audio signal or on the one or more initial audio features derived therefrom, depending on the desired manner of designing and applying the monitoring system 100.

The concept of speech related information represented by certain audio data as applied in the present disclosure is to be construed broadly, encompassing, for example, information pertaining to speech activity in the certain audio data, information pertaining to speech content in the certain audio data (such as words and/or phonemes included in the speech), and/or information pertaining to identity of the speaker in the certain audio data. Without losing generality, the speech related information possibly present in certain audio data may be considered as one or more speech characteristics represented by or derivable from the certain audio data and the one or more speech characteristics may enable, for example, identification of one or more of the following: speech activity in the certain audio data, speech content in the certain audio data, and/or identity of the speaker in the certain audio data. As an example in this regard, one or more predefined characteristics of speech (i.e. speech characteristics) may be considered. Hence, the conversion model may serve to convert the certain audio data into respective one or more audio features such that they include the information that facilitates (e.g. enables) identification an occurrence of any of the one or more predefined sound events in the certain audio data while inhibiting or preventing identification of the one or more predefined characteristics of speech possibly present in the certain audio data.

According to an example, the one or more initial audio features are predefined ones that have a previously known and/or observed relationship with the sound represented by the audio frame and the feature extraction procedure may be a hand-crafted one that relies on such previously known and/or observed relationships. In another example, the one or more initial audio features and the feature extraction procedure may be learned ones, obtained e.g. via application of a machine learning technique such as an artificial neural network (ANN) on experimental data. Regardless of the design strategy applied for building the feature extraction procedure, the one or more initial audio features obtained via its application on an audio frame are descriptive of the at least one characteristic of the sound represented by said audio frame. Examples of applicable (predefined) initial audio features derived from an audio frame include spectral features such as log-mel energies computed based on the audio frame, cepstral features such as mel-frequency cepstral coefficients computed based on the audio frame, etc.

Along the lines described in the foregoing, the one or more initial audio features may be subjected, in the audio preprocessor 111, to a conversion procedure via application of the predefined conversion model, resulting in the one or more audio features for transmission from the audio preprocessor 111 to the AED server 121. In particular, the conversion model may serve to convert the one or more initial audio features into the one or more audio features such that those sound characteristics represented by the initial one or more audio features that are applicable for identifying respective occurrences of the one or more predefined sound events are preserved in the one or more audio features while those sound characteristics of the one or more initial audio features that are descriptive of speech possibly present in the underlying audio frame are substantially suppressed or, preferably, completely eliminated. As an example in this regard, the conversion model may serve to inhibit, impede or prevent identification of occurrences of one or more predefined speech characteristics based on the one or more audio features, for example to an extent making performance of a speech classifier in identifying the speech characteristics based on the one or more audio features resulting from the conversion model substantially similar to that obtainable via applying the speech classifier on random data. Without losing generality, the conversion model may be considered as one that serves to map an initial audio feature vector that includes the one or more initial audio features derived for an audio frame into a corresponding audio feature vector that includes the one or more audio features for said audio frame. Due to the conversion applied, the audio feature vector including the one or more (converted) audio features may be also referred to as a converted audio feature vector.

This conversion procedure is illustrated in FIG. 4, where xᵢ∈ [symbol] ^{N}, denotes an initial audio feature vector obtained for an audio frame i, M denotes the conversion model and hᵢ∈ [symbol] ^{K} denotes an audio feature vector for the audio frame i, i.e. the one corresponding to the initial audio feature vector xᵢ. Herein, depending e.g. on characteristics of the conversion model M and the usage of the underlying monitoring system 100, the dimension N of the initial audio feature vector xᵢ may be smaller than, equal to, or larger than the dimension K or of the (converted) audio feature vector hᵢ. The audio preprocessor 111 may transfer (e.g. transmit) the audio feature vector hᵢ to the AED server 121 for the AE detection procedure therein. Since the conversion model M serves to suppress speech related information possibly present in the initial audio feature vector xᵢ while preserving information that facilitates (e.g. enables) carrying out the AED procedure for identification respective occurrences of the one or more predefined sound events in the AED server 121, the resulting audio feature vector hᵢ does not enable a third party that may obtain access thereto (e.g. by intercepting the transfer from the audio preprocessor 111 to the AED server 121 or by obtaining access to the audio feature vector hᵢ in the AED server 121) obtain speech related information that might compromise privacy of the monitored space in this regard.

According to a non-limiting example, the conversion model M may comprise an ANN known in the art, such as a multilayer perceptron (MLP). The MLP comprises an input processing layer, an output processing layer, and one or more intermediate (hidden) processing layers, where each processing layer comprises a respective plurality of nodes. Each node computes its respective output via applying an activation function to a linear combination of its inputs, where the activation function comprises a non-linear function such as tanh and where each node of a processing layer may apply a linear combination and/or a non-linear function that are different from those applied by the other nodes of the respective processing layer. The inputs to each node of the input processing layer of the MLP comprise elements of initial audio feature vector xᵢ(e.g. the one or more initial audio features), whereas input to the other processing layers comprise respective outputs of the nodes of the previous processing layer. Conversely, the respective outputs of the nodes of the input layer and any intermediate layer are provided as inputs to the nodes of the next processing layer, whereas the respective outputs of the nodes of the output processing layer constitute the audio feature vector hᵢ. In other examples, the conversion model M may rely on an ANN model different from the MLP, such as a convolutional neural network (CNN), a recurrent neural network (RNN) or a combination thereof.

Along the lines described in the foregoing, the AED server 121 may aim at identifying respective occurrences of the one or more predefined sound events in the monitored space. In this regard, the AED server 121 may be arranged carry out the sound event detection procedure in an attempt to identify respective occurrences of the one or more predefined sound events based on the one or more audio features received from the audio preprocessor 111. If an occurrence of any of the one or more predefined sound events is identified, the AED server 121 may transmit respective indications of the identified sound events to the AE processor 115. The sound event detection procedure may comprise applying a predefined sound event classifier to the one or more audio features in order to determine whether they represent any of the one or more predefined sound events. In this regard, without losing generality, the sound event classifier may be considered as one that serves to map an audio feature vector that includes the one or more audio features derived for an audio frame into corresponding one or more sound events (to extent the one or more audio features under consideration represent at least one of the one or more predefined sound events).

In this regard, the sound event detection procedure in order to identify respective occurrences of the one or more predefined sound events via usage of the sound event classifier generalizes into an acoustic event detection procedure in order to identify respective occurrences of the one or more acoustic events via usage of an acoustic event classifier, where another example of the acoustic event detection procedure includes the acoustic scene classification (ASC) procedure in order to identify respective occurrences of the one or more acoustic scenes via usage of an acoustic scene classifier.

This sound event detection procedure is illustrated in FIG. 5, where hᵢ∈ [symbol] ^{K} denotes the audio feature vector obtained for an audio frame i, C₁ denotes the sound event classifier and yᵢ denotes a sound event vector that includes respective identifications of those ones of the one or more predefined sound events that are represented by the audio feature vector hᵢ. In this regard, depending on the content of the audio feature vector hᵢ, the sound event vector yᵢ may include respective identifications of zero or more of the one or more predefined sound events. The AED server 121 may transfer (e.g. transmit) the sound event vector yᵢ and/or any identifications of the sound events included therein to the AE processor 115 for further processing therein. In an example, in case none of the one or more predefined sound events are identified based on the audio feature vector hᵢ, the AED server 121 may refrain from transmitting any indications in this regard to the AE processor 115, whereas in another example the AED server 121 may transmit a respective indication also in case none of the one or more predefined sound events are identified based on the in the audio feature vector hᵢ.

Along the lines described in the foregoing, the AE processor 115 may be arranged carry out one or more predefined actions in response to the AED server 121 identifying an occurrence of at least one of the one or more predefined sound events. These one or more actions depend on the purpose of the local device 110 hosting components of the monitoring system 100 and/or on the purpose of the monitoring system 100. However, a key aspect of the present disclosure includes identification of respective occurrences of the one or more predefined sound events in the monitored space and hence the exact nature of the one or more actions to be carried out by the AE processor 115 is not material to the present disclosure. Nevertheless, non-limiting examples of such actions include issuing an audible and/or visible notification or alarm locally and/or sending an indication or notification of the identified sound event to another entity, e.g. to another device, to inform a relevant party (e.g. an owner of the monitored space, security personnel, medical personnel, etc.) of the identified sound event.

As described in the foregoing, the conversion model M may serve to convert the one or more initial audio features in the initial audio feature vector xᵢ into the one or more audio features in the audio feature vector hᵢ such that those sound characteristics represented by the one or more initial audio features that are applicable for identifying respective occurrences of the one or more predefined sound events are preserved in the one or more audio features while those sound characteristics of the one or more initial audio features that are descriptive of speech possibly present in the underlying audio frame are suppressed or completely eliminated. In particular, the conversion by the conversion model M may result in the audio feature vector hᵢ including one or more audio features that facilitate (e.g. enable) reliable identification of respective occurrences of the one or more predefined sound events via operation of the sound event classifier C₁.

In the following, an exemplifying learning procedure for deriving the conversion model M and the sound event classifier C₁ is described. The learning procedure may also consider a speech classifier C₂ illustrated in FIG. 6, where hᵢ∈ [symbol] ^{K} denotes the audio feature vector obtained for an audio frame i, C₂ denotes the speech classifier and sᵢ denotes a speech characteristic vector that includes respective identifications of the speech characteristics identified based on the audio feature vector hᵢ. In this regard, depending on the content of the underlying audio frame, the speech characteristic vector sᵢ may include respective identifications of zero or more of the one or more predefined speech characteristics.

The learning procedure for deriving the conversion model M, the sound event classifier C₁ and the speech classifier C₂ may rely on usage of a respective machine learning model such as ANN, for example on a deep neural network (DNN) model. In this regard, ANNs serve as examples of applicable machine learning techniques and hence other methods and/or models may be applied instead without departing from the scope of the present disclosure. The learning may rely on a dataset D that includes a plurality of data items, where each data item represents or includes a respective audio data item together with respective indications of one or more sound events and/or one or more speech characteristics that may be represented by the respective audio item. The dataset D may comprise at least a first plurality of data items including respective audio items that represent the one or more predefined sound events and a second plurality of data items including respective audio items that represent one or more predefined speech characteristics.

An audio data item may comprise a respective segment of audio signal (e.g. an audio frame) or respective one or more initial audio features derived based on the segment of audio signal. Assuming, as an example, application of one or more initial audio features as the audio data items, each data item of the dataset D may be considered as a tuple dⱼ containing the following pieces of information:
an initial audio feature vector xⱼ,
a sound event vector yⱼ for the initial audio feature vector xⱼ, and
a speech characteristic vector sⱼ for the initial audio feature vector xⱼ.

Hence, each data item dⱼ of the dataset D includes the respective audio feature vector xⱼ together with the corresponding sound event vector yⱼ and the corresponding speech characteristic vector sⱼ that represent respective ground truth. Moreover, the speech event vectors sⱼ represent the type of speech information that is to be removed, which speech information may include information about speech activity, phonemes and/or speaker identity. In this regard, each of the audio feature vectors xⱼ, the sound event vectors yⱼ and the speech characteristic vectors sⱼ may be represented, for example, as respective vectors using one hot encoding. Distribution of the sound events and the audio events in the dataset D is preferably similar to their expected distribution in the actual usage scenario of the monitoring system 100.

As an example, derivation of the ANN (or another machine learning model) for serving as the sound event classifier C₁ may rely on supervised learning based on the data items of the dataset D such that for each data item dⱼ (the current version of) the conversion model M is applied to convert the initial audio feature vectors xⱼ of the data item dⱼ into the corresponding audio feature vector hⱼ. Consequently, the audio feature vectors hⱼ serve as a set of training vectors for training the ANN while the respective sound event vectors yᵢ of the dataset D represent the respective expected output of the ANN. The ANN resulting from the learning procedure is applicable for classifying an audio feature vector hᵢ obtained from any initial audio feature vector xᵢ via application of the conversion model M into one or more classes that correspond to the sound events the respective initial audio feature vector xᵢ represents, the ANN so obtained thereby serving as the sound event classifier C₁ that is able to identify possible occurrences of the one or more predefined sound events in the underlying initial audio feature vector xᵢ.

Along similar lines, as an example, derivation of the ANN (or another machine learning model) for serving as the speech classifier C₂ may rely on supervised learning based on the data items of the dataset D such that for each data item (the current version of) the conversion model M is applied to convert the initial audio feature vectors xⱼ of the data item dⱼ into the corresponding audio feature vector hⱼ. Consequently, the audio feature vectors hⱼ serve as a set of training vectors for training the ANN while the respective speech characteristic vectors sᵢ of the dataset D represent the respective expected output of the ANN. The ANN resulting from the learning procedure is applicable for classifying an audio feature vector hᵢ obtained from any initial audio feature vector xᵢ via application of the conversion model M into one or more classes that correspond to the speech characteristics the respective initial audio feature vector xᵢ represents, the ANN so obtained thereby serving as the speech classifier C₂ that is able to identify possible occurrences of the one or more predefined speech characteristics in the underlying initial audio feature vector xᵢ.

In an example, derivation of the respective ANNs (or another machine learning model) for serving as the conversion model M, the sound event classifier C₁ and the speech classifier C₂ may comprise applying supervised learning that makes use of the data items dⱼ of the dataset D, e.g. the initial audio feature vectors xⱼ together with the corresponding speech characteristic vectors sⱼ and the sound event vectors yⱼ, such that the conversion model M is trained jointly (e.g. in parallel with) the sound event classifier C₁ and the speech classifier C₂. In this regard, the supervised training may be carried out with stochastic gradient descent (SGD). Trainable parameters of the conversion model M, the sound event classifier C₁ and the speech classifier C₂ are first initialized, either by using random initialization, or using respective pre-trained models. The training is carried out as an iterative procedure, where at each iteration round a predicted speech vector ŝⱼ and a sound event vector ŷⱼ are then calculated via usage of (current versions of) the conversion model M, the sound event classifier C₁ and the speech classifier C₂. Moreover, at each iteration round respective values of two loss functions e₁ and e₂ are computed: the value of the loss function e₁ is descriptive of a difference between the predicted sound event vector ŷⱼ and the corresponding sound event vector yⱼ (that presents the ground truth in this regard), whereas the value of the loss function e₂ is descriptive of a difference between the predicted speech vector ŝⱼ and the corresponding speech characteristic vector sⱼ (that presents the ground truth in this regard). To complete the iteration round, respective gradients of the loss functions e₁ and e₂ with respect to the trainable parameters of the conversion model M are computed and, consequently, weights of the speech classifier C₂ are updated towards the negative of the gradient of e₂, whereas weights of the sound event classifier C₁ are updated towards the negative of the gradient of e₁. Weights of the conversion model M are updated towards the negative of the gradient e₁ and towards the gradient of e₁, thereby by applying so-called gradient reverse algorithm for training of the conversion model M. Iteration rounds including the above-described operations (i.e. computing the respective values of the loss functions e₁ and e₂, computing their gradients, and updating the weights of C₁, C₂ and M accordingly) are repeated until the iterative procedure converges. Applicable step sizes towards the gradients may be different for different losses, and optimal step sizes may be sought, for example, via usage of suitably selected validation data.

Referring back to the dataset D, each initial audio feature vector xⱼ may represent zero or more sound events of interest, whereas the sound event vector yⱼ may comprise respective zero or more sound event (SE) labels assigned to the initial audio feature vector xⱼ, thereby indicating (e.g. annotating) the respective sound events represented by the initial audio feature vector xⱼ (and appearing in the underlying audio frame). In this regard, the sound events of interest possibly represented by the initial audio feature vector xⱼ (i.e. those indicated by the sound event labels of the sound event vector yⱼ) include one or more of the one or more predefined sound events. Occurrences of sound events of interest in the tuples dᵢ of the dataset D contribute towards supervised learning of the conversion model M and the sound event classifier C₁ in order to facilitate recognition of such sound events based on the audio feature vectors hᵢ produced via application of the conversion model M in the course of operation of the monitoring system 100.

In addition to the zero or more sound events of interest, each initial audio feature vector xⱼ may represent zero or more speech characteristics, whereas the speech characteristic vector sⱼ may comprise respective zero or more speech characteristic labels assigned to the initial audio feature vector xⱼ, thereby indicating (e.g. annotating) the respective speech characteristics represented by the initial audio feature vector xⱼ (and appearing in the underlying segment audio signal). In this regard, the speech characteristics possibly represented by the audio feature vector j (i.e. those indicated by the speech characteristic labels of the speech characteristic vector sⱼ) include one or more of the one or more predefined speech characteristics. In this regard, the one or more predefined speech characteristics may include, for example, one or more of the following: presence of speech in the underlying audio frame, identification of a person having uttered speech captured in the underlying audio frame, speech content captured in the underlying audio frame, etc. Occurrences of the predefined speech characteristics in the tuples dᵢ of the dataset D contribute towards adversarial learning scenario for the conversion model M in order to substantially inhibit or prevent recognition of such speech characteristics based on the audio feature vectors hᵢ produced via application of the conversion model M in the course of operation of the monitoring system 100.

In addition to the sound events of interest and/or speech characteristics possibly included therein, the initial audio feature vector xⱼ may include further sound events, i.e. sound events that are neither sound events of interest nor acoustic events that represent any speech characteristics. Occurrences of such further sound events in the tuples dᵢ of the dataset D contribute towards adversarial learning scenario for the conversion model M and the sound event classifier C₁ in order to facilitate reliable recognition of the one or more sound events of interest based on the audio feature vectors hᵢ produced via application of the conversion model M in the course of operation of the monitoring system 100.

Hence, in summary, the dataset D may comprise a plurality of data items that represent occurrences of the one or more predefined sound events to facilitate deriving the conversion model M and the sound event classifier C₁ such that sufficient performance in recognizing the one or more predefined sound events is provided, a plurality of data items that represent occurrences of the one or more predefined speech characteristics to facilitate deriving the conversion model M such that the sufficient performance with respect to substantially preventing, inhibiting or impeding recognition of the one or more predefined speech characteristics is provided, and a plurality of further sound events to facilitate the conversion model M and/or the sound event classifier C₁ providing reliable recognition the one or more predefined sound events together with reliable suppression of information that might enable recognition of the one or more predefined speech characteristics.

The learning procedure for deriving the conversion model M and the sound event classifier C₁ may involve an iterative process that further involves derivation of the speech classifier C₂. The iterative learning procedure may be repeated until one or more convergence criteria are met. During the learning procedure, the conversion model M at an iteration round n may be denoted as Mₙ, whereas the sound event classifier C₁ at the iteration round n may be denoted as C_{1,n} and the speech classifier C₂ at the iteration round n may be denoted as C_{2,n}. The respective settings for the conversion model M₁, the sound event classifier C_{1,1} and the speech classifier C_{2,1} for the initial iteration round n=1 may comprise, for example, respective predefined values or respective random values.

At each iteration round, the learning procedure involves, across data items (and hence across initial audio feature vectors xⱼ) of the dataset D, applying the conversion model Mₙ to the respective initial audio feature vector xⱼ to derive respective audio feature vector hⱼ, applying the sound event classifier C_{1,n} to the audio feature vector hⱼ to identify respective occurrences of the one or more predefined sound events represented by the initial audio feature vector xᵢ, and applying the speech classifier C_{2,n} to the audio feature vector hⱼ to identify respective occurrences of the one or more predefined speech characteristics represented by the initial audio feature vector xⱼ. Furthermore, the respective identification performances of the sound event classifier C_{1,n} and the speech classifier C_{2,n} are evaluated. As examples in this regard, the identification performance of the sound event classifier C_{1,n} may be evaluated based on differences between the identified occurrences of the one or more predefined sound events in an initial audio feature vector xⱼ and their actual occurrences in the respective initial audio feature vector xⱼ across the dataset D, whereas the identification performance of the speech classifier C_{2,n} may be evaluated based on differences between the identified occurrences of the one or more predefined speech characteristics in an initial audio feature vector xⱼ and their actual occurrences in the respective initial audio feature vector xⱼ across the dataset D.

Moreover, the learning procedure at the iteration round n involves updating a sound event classifier C_{1,n} into sound event classifier C_{1,n+1} that provides improved identification of respective occurrences of the one or more predefined sound events across the initial audio feature vectors xⱼ of the dataset D, updating a speech classifier C_{2,n} into a speech classifier C_{2,n+1} that provides improved identification of respective occurrences of the one or more predefined speech characteristics across the initial audio feature vectors xⱼ of the dataset D, and updating a conversion model Mₙ into a conversion model Mₙ₊₁ that results in improved identification of respective occurrences of the one or more predefined sound events via usage of the sound event classifier C_{1,n} but impaired identification of respective occurrences of the one or more predefined speech characteristics via usage of the speech classifier C_{2,n} across the initial audio feature vectors xⱼ of the dataset D. In this regard, each of the sound event classifier C_{1,n} and the speech classifier C_{2,n} may be updated in dependence of their respective identification performances at the iteration round n, whereas the conversion model Mₙ may be updated in dependence of the respective identification performances of the sound event classifier C_{1,n} and the speech classifier C_{2,n} at the iteration round n. Hence, at each iteration round n the learning procedure aims at improving the respective performances of the sound event classifier C_{1,n} and the speech classifier C_{2,n} while updating the conversion model Mₙ to facilitate improved identification of respective occurrences of the one or more predefined sound events by the sound event classifier C_{1,n} while making it more difficult for the speech classifier C_{2,n} to identify respective occurrences of the one or more predefined speech characteristics.

As a further non-liming example, the iterative learning procedure may comprise the following steps at each iteration round n:
1. Apply the conversion model Mₙ to each initial audio feature vector xᵢⱼ of the dataset D to derive a respective audio feature vector h_{j,n}.
2. Apply the sound event classifier C_{1,n} to each audio feature vector h_{j,n} of the dataset D to derive a respective estimated sound event vector ŷ_{j,n}.
3. Apply the speech classifier C_{2,n} to each audio feature vector h_{j,n} of the dataset D to derive a respective estimated speech characteristic vector ŝ_{j,n}.
4. Compute a respective first difference measure e_{1,j,n}=diff₁(yⱼ, ŷ_{j,n}) for each pair of the sound event vector y, and the corresponding estimated sound event vector ŷ_{j,n} across the dataset D, where the first difference measure e_{1,j,n} is descriptive of the difference between the sound event vector yⱼ and the corresponding estimated sound event vector ŷ_{j,n} and where diff₁( ) denotes a first predefined loss function that is applicable for computing the first difference measures e_{1,j,n}. The first difference measures e_{1,j,n} may be arranged into a first difference vector e_{1,n}.
5. Compute a respective second difference measure e_{2,j,n}=diff₂(sⱼ, ŝ_{j,n}) for each pair of the speech characteristic vector sⱼ and the corresponding estimated speech characteristic vector ŝ_{j,n} across the dataset D, where the second difference measure e_{2,j,n} is descriptive of the difference between the speech characteristic vector sⱼ and the corresponding estimated speech characteristic vector ŝ_{j,n} and where diff₂( ) denotes a second predefined loss function that is applicable for computing the second difference measures e_{2,j,n}. The second difference measures e_{2,j,n} may be arranged into a second difference vector e_{2,n}.
6. Update, using an applicable machine-learning technique in dependence of the first difference vector e_{1,n}, the sound event classifier C_{1,n} into the sound event classifier C_{1,n+1} that provides improved identification of respective occurrences of the one or more predefined sound events across the dataset D.
7. Update, using an applicable machine-learning technique in dependence of the second difference vector e_{2,n}, the speech classifier C_{2,n} into the speech classifier C_{2,n+1} that provides improved identification of respective occurrences of the one or more predefined speech characteristics across the dataset D.
8. Update, using an applicable machine-learning technique in dependence of the first difference vector e_{1,n} and the second difference vector e_{2,n}, the conversion model Mₙ into the conversion model Mₙ₊₁ that results in improved identification of respective occurrences of the one or more predefined sound events via usage of the sound event classifier C_{1,n} but impaired identification of respective occurrences of the one or more predefined speech characteristics via usage of the speech classifier C_{2,n} across the dataset D.

According to an example, in step 4 above the first predefined loss function diff₁( ) applied in computation of the first difference measures e_{1,j,n} may comprise any suitable loss function known in the art that is suitable for the applied machine learning technique and/or model. Along similar lines, according to an example, in step 5 above the second predefined loss function diff₂( ) applied in computation of the second difference measure e_{2,j,n} may comprise any suitable loss function known in the art that is suitable for the applied machine learning technique and/or model. As non-limiting examples in this regard, applicable loss functions include cross-entropy and mean-square error.

According to an example, the aspect of updating the sound event classifier C_{1,n} into the sound event classifier C_{1,n+1} in step 6 above may comprise modifying the internal operation of the sound event classifier C_{1,n} in accordance with the applicable machine-learning technique such that it results in reducing a first error measure derivable based on the first difference vector e_{1,n}. Along similar lines, according to an example, the aspect of updating the speech classifier C_{2,n} into the speech classifier C_{2,n+1} in step 7 above may comprise modifying the internal operation of the speech classifier C_{2,n} in accordance with the applicable machine-learning technique such that it results in reducing a second error measure derivable based on the second difference vector e_{2,n}.

According to an example, in step 8 above the aspect of updating the conversion model Mₙ into a conversion model Mₙ₊₁ in step 8 above may comprise modifying the internal operation of the conversion model Mₙ in accordance with the applicable machine-learning technique such that it results in maximizing the second error measure derivable based on the second difference vector e_{2,n} while decreasing the first error measure derivable based on the first difference vector e_{1,n}.

Along the lines described in the foregoing, the iterative learning procedure, e.g. one according to the above steps 1 to 8, may be repeated until the one or more convergence criteria are met. These convergence criteria may pertain to performance of the of the sound event classifier C_{1,n} and/or to performance of the speech classifier C_{2,n}. Non-limiting examples in this regard include the following:
The iterative learning procedure may be terminated in response to classification performance of the sound event classifier C_{1,n} reaching or exceeding a respective predefined threshold value, e.g. a percentage of correctly identified sound events reaching or exceeding a respective predefined target value or a percentage of incorrectly identified sound events reducing to or below a respective predefined target value.
Alternatively or additionally, the iterative learning procedure may be terminated in response to classification performance of the sound event classifier C_{1,n} failing to improve in comparison to the previous iteration round by at least a respective predefined amount, e.g. a percentage of correctly identified sound events failing to increase or a percentage of incorrectly identified sound events failing to decrease by at least a respective predefined amount.
Alternatively or additionally, the iterative learning procedure may be terminated in response to classification performance of the speech classifier C_{2,n} reducing to or below a respective predefined threshold value, e.g. a percentage of incorrectly identified speech characteristics reaching or exceeding a respective predefined target value or a percentage of correctly identified speech characteristics reducing to or below a respective predefined target value.

Hence, the conversion model Mₙ and the sound event classifier C_{1,n} at the iteration round where the applicable one or more convergence criteria are met may be applied as the conversion model M and the sound event classifier C₁ in the course of operation of the monitoring system 100.

In the foregoing, operation of the monitoring system 100 and the learning procedure for deriving the conversion model M and the sound event classifier C₁ useable in the course of operation of the monitoring system 100 are predominantly described with references to a scenario where the audio data items considered in the learning procedure comprises respective initial audio feature vectors xⱼ including the respective one or more initial audio features that represent at least one characteristic of a respective time segment of an audio signal and that may have been derived from said time segment of the audio signal via usage of the predefined feature extraction procedure. In a variation of such an approach, the audio data items considered in the learning procedure may comprise the respective segments of the audio signal and, consequently, the conversion model M resulting from the learning procedure may be applicable for converting a time segment of audio signal into the audio feature vector hⱼ including one or more audio features and the audio preprocessor 111 making use of such a conversion model may operate to derive the audio feature vectors hᵢ based on time segments of audio signal. In a further variation in this regard, the audio data items considered in the learning procedure and the audio data applied as basis for deriving the audio feature vectors hᵢ in the audio preprocessor 111 may comprise a transform-domain audio signal that may have been derived based on a respective time segment of audio signal via usage of an applicable transform, such as the discrete cosine transform (DCT).

In the foregoing, operation of the monitoring system 100 and the learning procedure for deriving the conversion model M are predominantly described with references to using the AED server 121 for identification of the one or more predefined sound events while deriving the sound event classifier C₁ that enables identification of respective occurrences of the one or more predefined sound events in the course of operation of the monitoring system 100. However, as described in the foregoing, in another example the monitoring system 100 may be applied for identification of respective occurrences of the one more predefined acoustic scenes based on the one or more audio features derived via usage of the conversion model M. The learning procedure described in the foregoing applies to such a scenario as well with the following exceptions:
Instead of deriving the sound event classifier C₁, the learning procedure operates to derive an acoustic scene classifier, which may be likewise denoted as C₁. In this regard, the sound event classifier and the acoustic scene classifier readily generalize into the acoustic event classifier C₁.
Instead of the sound event vectors yᵢ, each data item of the dataset D contains a respective acoustic scene vector (that may be likewise denoted as yᵢ and) that comprises zero or more acoustic scene labels assigned to the initial audio feature vector xᵢ of the respective data item. In this regard, the sound event vectors and the acoustic scene vectors readily generalize into acoustic event vectors yᵢ.

The conversion model M and the acoustic scene classifier C₁ resulting from such a learning procedure may be applied in the course of operation of the monitoring system 100 for identification of respective occurrences of the one or more predefined acoustic scenes as described in the foregoing with references to using the corresponding elements for identification of respective occurrences of the one or more predefined sound events, mutatis mutandis.

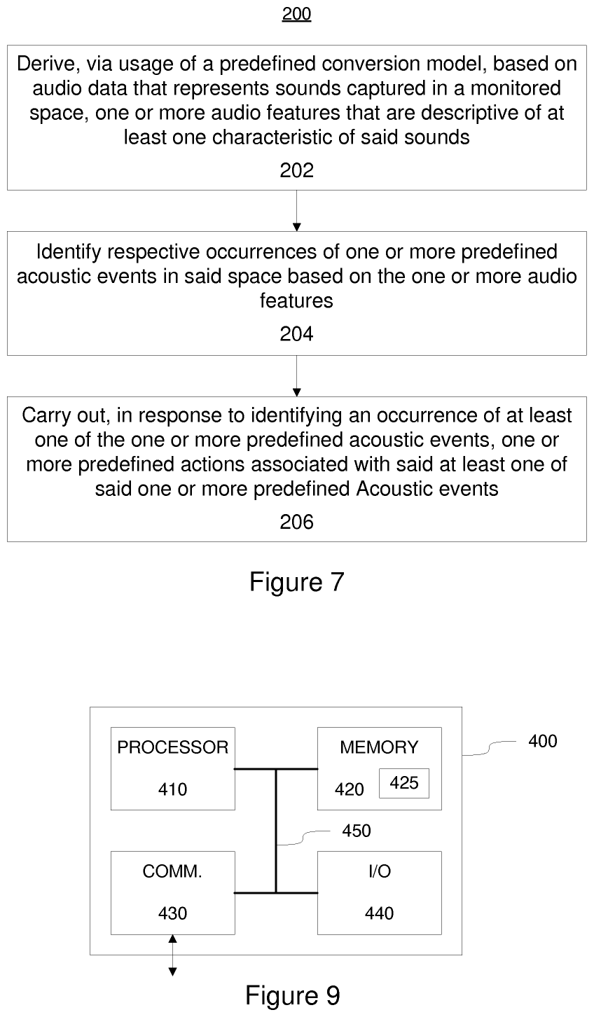

In the foregoing, the operation pertaining to derivation of the one or more audio features based on audio data and their application for identifying respective occurrences of the one or more predefined acoustic events represented by the audio data are described with references to the monitoring system 100 and/or to the audio preprocessor 111 and the AED server 121 therein. These operations may be alternatively described as steps of a method. As an example in this regard, FIG. 7 depicts a flowchart illustrating a method 200, which may be carried out, for example, by the audio preprocessor 111 and the AED server 121 in the course of their operation as part of the monitoring system 100. Respective operations described with references to blocks 202 to 206 pertaining to the method 200 may be implemented, varied and/or complemented in a number of ways, for example as described with references to elements of the monitoring system 100 in the foregoing and in the following.

The method 200 commences from deriving, via usage of the predefined conversion model M, based on audio data that represents sounds captured in a monitored space, one or more audio features that are descriptive of at least one characteristic of said sounds, as indicated in block 202. The method 200 further comprises identifying respective occurrences of the one or more predefined acoustic events in said space based on the one or more audio features, as indicated in block 204, and carrying out, in response to identifying an occurrence of at least one of said one or more predefined acoustic events, one or more predefined actions associated with said at least one of said one or more predefined acoustic events, as indicated in block 206. In context of the method 200, the conversion model M is trained to provide said one or more audio features such that they include information that facilitates identification of respective occurrences of said one or more predefined acoustic events while substantially preventing identification of speech characteristics.

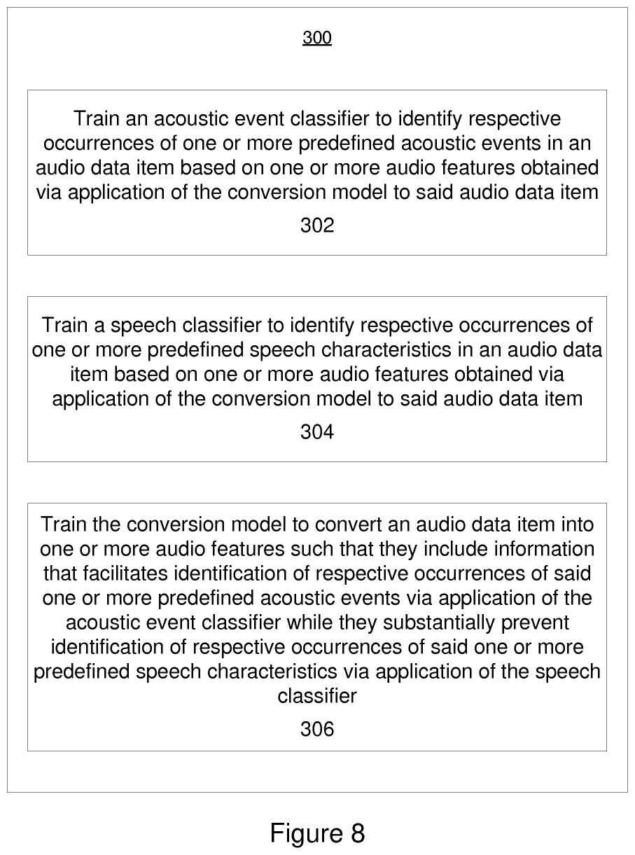

As another example, FIG. 8 illustrates a method 300, which may be carried out by one or more computing devices to carry out the learning procedure for deriving the conversion model M and the acoustic event classifier C₁ described in the foregoing. Respective operations described with references to blocks 302 to 308 pertaining to the method 300 may be implemented, varied and/or complemented in a number of ways, for example as described with references to learning procedure in the foregoing and in the following.

The method 300 serves to derive the conversion model M and the acoustic event classifier C₁ via application of machine learning to jointly derive the conversion model M, the acoustic event classifier C₁ and the speech classifier C₂ via the iterative learning procedure based on the dataset D described in the foregoing. The method 300 comprises training the acoustic event classifier C₁ to identify respective occurrences of the one or more predefined acoustic events in an audio data item based on one or more audio features obtained via application of the conversion model M to said audio data item, as indicated in block 302, and training the speech classifier C₂ to identify respective occurrences of the one or more predefined speech characteristics in an audio data item based on one or more audio features obtained via application of the conversion model M to said audio data item, as indicated in block 304. The method 300 further comprises training the conversion model M to convert an audio data item into one or more audio features such that they include information that facilitates identification of respective occurrences of said one or more predefined acoustic events via application of the acoustic event classifier C₁ while they substantially prevent identification of respective occurrences of said one or more predefined speech characteristics via application of the speech classifier C₂, as indicated in block 306.

The illustration of FIG. 8 is not to be construed as a flowchart representing a sequence of processing steps but the respective operations of blocks 302, 304 and 306 may be carried out at least partially in parallel and they may be repeated in an iterative manner until the procedure of training the conversion model M converges to a desired extent. As an example in this regard, training of each of the acoustic event classifier C₁, the speech classifier C₂ and the conversion model M may be carried out as a joint iterative training procedure (as described in the foregoing). In another example, an existing (e.g. previously trained) conversion model M may be applied as such, while an iterative procedure involving training of the acoustic event classifier C₁ and the speech classifier C₂ may be applied, where the iteration may be continued until the one or both of the acoustic event classifier C₁ and the speech classifier C₂ converge to a desired extent.

FIG. 9 schematically illustrates some components of an apparatus 400 that may be employed to implement operations described with references to any element of the monitoring system 100 and/or the learning procedure for deriving the conversion model M and the acoustic event classifier C₁. The apparatus 400 comprises a processor 410 and a memory 420. The memory 420 may store data and computer program code 425. The apparatus 400 may further comprise communication means 430 for wired or wireless communication with other apparatuses and/or user I/O (input/output) components 440 that may be arranged, together with the processor 410 and a portion of the computer program code 425, to provide the user interface for receiving input from a user and/or providing output to the user. In particular, the user I/O components may include user input means, such as one or more keys or buttons, a keyboard, a touchscreen or a touchpad, etc. The user I/O components may include output means, such as a display or a touchscreen. The components of the apparatus 400 are communicatively coupled to each other via a bus 450 that enables transfer of data and control information between the components.

The memory 420 and a portion of the computer program code 425 stored therein may be further arranged, with the processor 410, to cause the apparatus 400 to perform at least some aspects of operation of the audio preprocessor 111, the AED server 121 or the learning procedure described in the foregoing. The processor 410 is configured to read from and write to the memory 420. Although the processor 410 is depicted as a respective single component, it may be implemented as respective one or more separate processing components. Similarly, although the memory 420 is depicted as a respective single component, it may be implemented as respective one or more separate components, some or all of which may be integrated/removable and/or may provide permanent/semi-permanent/dynamic/cached storage.

The computer program code 425 may comprise computer-executable instructions that implement at least some aspects of operation of the audio preprocessor 111, the AED server 121 or the learning procedure described in the foregoing when loaded into the processor 410. As an example, the computer program code 425 may include a computer program consisting of one or more sequences of one or more instructions. The processor 410 is able to load and execute the computer program by reading the one or more sequences of one or more instructions included therein from the memory 420. The one or more sequences of one or more instructions may be configured to, when executed by the processor 410, cause the apparatus 400 to perform at least some aspects of operation of the audio preprocessor 111, the AED server 121 or the learning procedure described in the foregoing. Hence, the apparatus 400 may comprise at least one processor 410 and at least one memory 420 including the computer program code 425 for one or more programs, the at least one memory 420 and the computer program code 425 configured to, with the at least one processor 410, cause the apparatus 400 to perform at least some aspects of operation of the audio preprocessor 111, the AED server 121 or the learning procedure described in the foregoing.

The computer program code 425 may be provided e.g. a computer program product comprising at least one computer-readable non-transitory medium having the computer program code 425 stored thereon, which computer program code 425, when executed by the processor 410 causes the apparatus 400 to perform at least some aspects of operation of the audio preprocessor 111, the AED server 121 or the learning procedure described in the foregoing. The computer-readable non-transitory medium may comprise a memory device or a record medium such as a CD-ROM, a DVD, a Blu-ray disc or another article of manufacture that tangibly embodies the computer program. As another example, the computer program may be provided as a signal configured to reliably transfer the computer program.

Reference(s) to a processor herein should not be understood to encompass only programmable processors, but also dedicated circuits such as field-programmable gate arrays (FPGA), application specific circuits (ASIC), signal processors, etc. Features described in the preceding description may be used in combinations other than the combinations explicitly described.

1. A monitoring system comprising:
an audio preprocessor arranged to derive, via usage of a predefined conversion model, based on audio data that represents sounds captured in a monitored space, one or more audio features that are descriptive of at least one characteristic of said sounds;
an acoustic event detection server arranged to identify respective occurrences of one or more predefined acoustic events in said space based on the one or more audio features; and
an acoustic event processor arranged to carry out, in response to identifying an occurrence of at least one of said one or more predefined acoustic events, one or more predefined actions associated with said at least one of said one or more predefined acoustic events,
wherein said conversion model is trained to provide said one or more audio features such that they include information that facilitates identification of respective occurrences of said one or more predefined acoustic events while substantially preventing identification of speech characteristics.

2. The monitoring system according to claim 1, wherein the acoustic event detection server is arranged to identify said occurrences of said one or more predefined acoustic events via usage of an acoustic event classifier that is trained to detect respective occurrences of said one or more predefined acoustic events based on the one or more audio features.

3. The monitoring system according to claim 1, wherein said conversion model is trained to substantially prevent identification of respective occurrences of one or more predefined speech characteristics.

4. The monitoring system according to claim 1, wherein the audio data comprises one or more initial audio features that are descriptive of at least one characteristic of said sounds and wherein the audio preprocessor is arranged to apply the conversion model to the one or more initial audio features to derive said one or more audio features that include the information that facilitates identification an occurrence of any of said one or more predefined acoustic events while substantially preventing identification of speech characteristics.

5. The monitoring system according to claim 4, wherein the audio preprocessor is arranged to apply a predefined feature extraction procedure to an audio signal that represents the sounds captured in said space to derive said one or more initial audio features.

6. The monitoring system according to claim 4, wherein said one or more initial audio features comprise one or more of the following: spectral features derived based on the audio data, cepstral features derived based on the audio data.

7. The monitoring system according to claim 1, wherein the audio data comprises an audio signal that represents the sounds captured in said space and wherein the audio preprocessor is arranged to apply the conversion model to the audio signal to derive said one or more audio features that include the information that facilitates identification an occurrence of any of said one or more predefined acoustic events while substantially preventing identification of speech characteristics.

8. The monitoring system according to claim 1, wherein at least the audio preprocessor is provided in a first device and at least the acoustic event detection server is provided in a second device that is communicatively coupled to the first device via a communication network.

9. An apparatus for deriving a conversion model for converting an audio data item that represents captured sounds into one or more audio features that are descriptive of at least one characteristic of said sounds and for deriving an acoustic event classifier, the apparatus arranged to apply respective machine learning models to jointly derive the conversion model, the acoustic event classifier and a speech classifier via an iterative learning procedure based on a predefined dataset that includes a plurality of data items that represent respective captured sounds comprising at least a first plurality of data items including respective audio data items that represent one or more predefined acoustic events and a second plurality of data items including respective audio data items that represent one or more predefined speech characteristics, wherein the apparatus is arranged to:
apply a first machine learning model to train the acoustic event classifier to identify respective occurrences of said one or more predefined acoustic events in an audio data item based on one or more audio features obtained via application of the conversion model to said audio data item,
apply a second machine learning model to train the speech classifier to identify respective occurrences of said one or more predefined speech characteristics in an audio data item based on one or more audio features obtained via application of the conversion model to said audio data item, and
apply a third machine learning model to train the conversion model to convert an audio data item into one or more audio features such that they include information that facilitates identification of respective occurrences of said one or more predefined acoustic events via application of the acoustic event classifier while they substantially prevent identification of respective occurrences of said one or more predefined speech characteristics via application of the speech classifier.

10. The apparatus according to claim 9, wherein the iterative learning procedure comprises, at each iteration round, the following:
applying, to the audio data items of the dataset, the conversion model to a respective audio item to derive respective one or more audio features, applying the acoustic event classifier to the respective one or more audio features to identify respective occurrences of said one or more predefined acoustic events in the respective audio data item and applying the speech classifier to the respective one or more audio features to identify respective occurrences of said one or more predefined speech characteristics in the respective audio data item;
evaluating respective identification performances of the acoustic event classifier and the speech classifier;
updating, in dependence of its identification performance, the acoustic event classifier to provide improved identification of respective occurrences of said one or more predefined acoustic events;
updating, in dependence of its identification performance, the speech classifier to provide improved identification of respective occurrences of said one or more predefined speech characteristics; and
updating, in dependence of the respective identification performances of the acoustic event classifier and the speech classifier the conversion model to facilitate improved identification of respective occurrences of said one or more predefined acoustic events via operation of the acoustic event classifier while impairing identification of respective occurrences of said one or more predefined speech characteristics via operation of the speech classifier.

11. The apparatus according to claim 10, wherein the iterative learning procedure is continued until one or more convergence criteria pertaining to performance of the acoustic event classifier and/or to performance of the speech classifier are met.

12. The apparatus according to claim 11, wherein the one or more convergence criteria comprise one or more of the following:
classification performance of the acoustic event classifier has reached a respective predefined threshold value,
improvement in classification performance of the acoustic event classifier fails to exceed a respective predefined threshold value,
classification performance of the speech classifier has reduced below a respective predefined threshold value.

13. The apparatus according to claim 10, wherein each of said plurality of data items of the dataset comprises the following:
a respective audio data item that represents respective captured sounds,
a respective acoustic event vector that comprises respective indications of those ones of said one or more predefined acoustic events that are represented by the respective audio data item, and
a respective speech characteristics vector that comprises respective indications of those ones of said one or more predefined speech characteristics that are represented by the respective audio data item.

14. The apparatus according to claim 13, wherein the iterative learning procedure comprises:
computing, for each data item, a respective first difference measure that is descriptive of the difference between the acoustic events indicated in the acoustic event vector of the respective data item and acoustic events identified based on one or more audio features obtained via application of the conversion model on the audio data item of the respective data item,
computing, for each data item, a respective second difference measure that is descriptive of the difference between the speech characteristics indicated in the speech characteristics vector of the respective data item and speech characteristics identified based on one or more audio features obtained via application of the conversion model (M) on the audio data item of the respective data item, and
updating the acoustic event classifier based on the first differences, updating the speech classifier based on the second differences, and updating the conversion model based on the first and second differences.

15. The apparatus according to claim 9, wherein each audio data item comprises one of the following:
a respective segment of audio signal that represents respective captured sounds,
respective one or more initial audio features that represent at least one characteristic of respective captured sounds.

16. The apparatus according to claim 9, wherein the machine learning comprises application of an artificial neural network model, such as a deep neural network model.

17. The apparatus according to claim 9, wherein the one or more predefined acoustic events comprise one of the following:
one or more predefined sound events,
one or more predefined acoustic scenes.

18. The apparatus according to claim 9,
wherein an input to the acoustic event classifier comprises said one or more audio features obtained via application of the conversion model and wherein an output of the acoustic event classifier comprises respective indications of one or more classes that correspond to acoustic events said one or more audio features serve to represent;
wherein an input to the speech classifier comprises said one or more audio features obtained via application of the conversion model and wherein an output of the speech classifier comprises respective indications of one or more classes that correspond to speech characteristics said one or more audio features serve to represent.

19. A method for audio-based monitoring, the method comprising:
deriving, via usage of a predefined conversion model, based on audio data that represents sounds captured in a monitored space, one or more audio features that are descriptive of at least one characteristic of said sounds;
identifying respective occurrences of one or more predefined acoustic events in said space based on the one or more audio features; and
carrying out, in response to identifying an occurrence of at least one of said one or more predefined acoustic events, one or more predefined actions associated with said at least one of said one or more predefined acoustic events,
wherein said conversion model is trained to provide said one or more audio features such that they include information that facilitates identification of respective occurrences of said one or more predefined acoustic events while substantially preventing identification of speech characteristics.

20. A method for deriving a conversion model for converting an audio data item that represent captured sounds into one or more audio features that are descriptive of at least one characteristic of said sounds and an acoustic event classifier via application of machine learning to jointly derive the conversion model, the acoustic event classifier and for deriving a speech classifier via an iterative learning procedure based on a predefined dataset that includes a plurality of data items that represent respective captured sounds comprising at least a first plurality of data items including respective audio data items that represent one or more predefined acoustic events and a second plurality of data items including respective audio data items that represent one or more predefined speech characteristics, the method comprising:
applying a first machine learning model for training the acoustic event classifier to identify respective occurrences of said one or more predefined acoustic events in an audio data item based on one or more audio features obtained via application of the conversion model to said audio data item;
applying a second machine learning model for training the speech classifier to identify respective occurrences of said one or more predefined speech characteristics in an audio data item based on one or more audio features obtained via application of the conversion model to said audio data item; and
applying a third machine learning model for training the conversion model to convert an audio data item into one or more audio features such that they include information that facilitates identification of respective occurrences of said one or more predefined acoustic events via application of the acoustic event classifier while they substantially prevent identification of respective occurrences of said one or more predefined speech characteristics via application of the speech classifier.

21. A computer program product comprising computer readable non-transitory medium arranged to store program code configured to cause performing of the method according to claim 19 when said program code is run on one or more computing apparatuses.

22. A computer program product comprising computer readable non-transitory medium arranged to store program code configured to cause performing of the method according to claim 20 when said program code is run on one or more computing apparatuses.
